(19) United States
(12) Patent Application Publication
(10) Pub. No.: US 2002/0019828 A1
(43) Pub. Date: Feb. 14, 2002

(54) Computer-implemented method and apparatus for obtaining permission based data

(76) Inventor: William M. Mortl, Yorkville, IL (US)

Correspondence Address: MCDERMOTT WILL & EMERY, 600 13TH STREET, N.W., WASHINGTON, DC, 20005-3096, US

(21) Appl. No.: 09/876,223

(22) Filed: Jun. 8, 2001

Related U.S. Application Data
(60) Provisional application No. 60/222,611, filed on Aug. 2, 2000.
(60) Provisional application No. 60/210,454, filed on Jun. 9, 2000.

(51) Int. Cl. G06F 17/30

(52) U.S. Cl. 707/200; 707/1

(57) ABSTRACT

An apparatus and method for determining whether a web site operator or online service may collect and/or receive personal information from a computer user accessing a web site or online service includes storing and accessing permission parameters at a centralized location. When a computer user accesses a web site or online service, the web site or online service receives permission parameters from the centralized location. The permission parameters are then utilized to determine whether and/or to what extent the web site or online service may collect and/or receive personal information from the computer user.

### CROSS REFERENCE TO RELATED APPLICATIONS

This application claims the benefit of U.S. Provisional Patent Application Ser. No. 60/222,611 filed, Aug. 2, 2000, and U.S. Provisional Patent Application Ser. No. 60/210,454 filed, Jun. 9, 2000, the entire disclosures of which are incorporated herein by reference.

### FIELD OF THE INVENTION

The present invention generally relates to a computer-implemented method and apparatus for obtaining permission based data related to the collection of personal user information over the Internet.

### BACKGROUND OF THE INVENTION

In 1998, the United States Congress passed the Children's Online Privacy Protection Act (COPPA) in an effort to protect the privacy of children using the Internet. Before collecting, using, disclosing, or displaying personal information collected from children under the age of 13, COPPA requires operators of online services and/or web sites to obtain parental consent. Web sites and online services directed to, or that knowingly collect information from, children under the age of 13 must inform parents of the information practices utilized by the web sites and online services. With certain statutory exceptions, commercial web sites and online services must obtain “verifiable parental consent” before collecting, using or disclosing personal information collected from children. Rules established for COPPA's implementation, which took effect Apr. 21, 2000, give web sites and online services six months to comply with the rules' requirements.

Compliance with COPPA raises several problems and concerns. Online services and web site operators who collect and compile information about the users who access their web sites must determine how to comply with COPPA's provisions, and parents must be able to grant or deny permission for web site operators and online services to collect personal information from children who access web site operators' and online services' web sites.

The issue of how web sites and online services obtain “verifiable parental consent” is an open issue generating debate regarding compliance with COPPA. There is currently a need for a system that allows web sites and online services to effectively verify parental consent before personal information is collected from children. Additionally, it is difficult for parents to access each web site or online service that their child accesses, or may access, in order to grant permission before personal information is collected from their child.

In light of recent concern over collection of personal information over the Internet, adults also desire to control what personal information is collected from them. Many current web sites and online services post their information collection policy, and describe what is done with personal information once it has been collected. However, finding and reading personal information collection policies is often cumbersome and time consuming.

Additionally, there are no safeguards to prevent a web site or online service from misrepresenting what type of information is collected and how the information is subsequently utilized.

Accordingly, there is a need for a comprehensive solution for obtaining permission by web site operators and online services to collect personal information from persons using the Internet. There is a particular need for a solution enabling parents to define what personal information may be collected from their children over the Internet, and for parents to define how their children's personal information is utilized after collection. From a site operators' perspective, there is a need for a technique to quickly, efficiently and/or cost-effectively obtain verifiable consent to collect information. The present invention addresses at least the above needs.

### SUMMARY OF THE INVENTION

It is an object of the present invention to provide a computer-implemented method whereby users can define a level of permission granted to web site operators and online services for collecting personal information about themselves.

In particular, it is an object of the present invention to provide a centralized location or computer where adults define a level of permission granted to web site operators and online services for collecting personal information about themselves and about minors for whom the adults are legally recognized guardians.

It is another object of the present invention to provide automated verification of the level of permission granted by an adult regarding collection of personal information via the Internet from the adult and/or any minors for whom the adult is a guardian. Automatic verification allows web site operators and online services to comply with the provisions of COPPA, its implementing legislation, and similar regulatory regimes without waiting for a direct response from a minor's guardian. Such automatic verification also provides safeguards against collecting personal information via the Internet in anticipation of the next generation of legislation designed to protect against unwanted collection of and dissemination of personal information.

It is a further object of the present invention to provide a centralized location where Internet users define a level of permission granted to web site operators and online services that must be followed in order for personal information to be collected from an Internet user.

To accomplish the above and other objects or technical effects, the present invention provides a database comprising permission parameter sets for each registered minor, and for each registered adult, where each permission parameter set contains a level of permission regarding collection of personal information via the Internet from the minor or adult. The present invention also provides access to each minor's and to each adults level of permission and corresponding personal information by registered web site operators and online services.

Accordingly, an aspect of the inventive method provides control over what information is collected from an Internet user by storing at a centralized location for each user a permission parameter set that governs the collection of personal information regarding the user associated with each permission parameter set. A computer retrieves a permission parameter associated with the user when the user accesses the Internet site, and a determination is made whether the Internet site is able to obtain personal information about the user based upon the stored permission parameter set regarding the user. The Internet site then obtains personal information about the user based upon the determination whether the Internet site is able to obtain personal information about the user.

Accordingly, another aspect of the inventive method provides a method for determining whether personal information may be collected from a computer user accessing an Internet site comprising the steps of: transmitting an Internet site request from the user's computer to a first Internet server that functions as the Internet site; redirecting the Internet site request to a second Internet server; retrieving data from the user's computer by the second Internet server in response to the redirected Internet site request; determining whether the computer user is older than a predetermined age at the second Internet server based at least in part upon the retrieved data from the user's computer; and transmitting a permission parameter that indicates what personal information may be collected from the computer user, based upon determining whether the computer user is older than a predetermined age, from the second Internet server to the first Internet server.

In certain embodiments, the inventive method includes retrieving data from the user's computer, and basing the transmitted permission parameter on the retrieved data.

Another aspect of the present invention relates to a method for determining whether personal information may be collected from a computer user comprising the steps of: transmitting an Internet site request from the user's computer to a first Internet server that functions as the Internet site; redirecting the Internet site request to a second Internet server; retrieving data from the user's computer by the second Internet server in response to the redirected Internet site request; retrieving a permission parameter set that governs collection of personal information from the user utilizing the data retrieved from the user's computer; determining at the second Internet server whether the computer user has personal information authorized for collection based at least in part upon the retrieved permission parameter set; and transmitting a permission parameter that governs what personal information may be collected from the computer user, based at least in part upon the permission parameter set, from the second Internet server to the first Internet server.

A further aspect of the present invention relates to a method for determining whether personal information may be collected from a computer user accessing an Internet site comprising the steps of: receiving a redirected Internet site request at a verification computer; retrieving data from the user's computer by the verification computer; determining whether the computer user is older than a predetermined age based upon the data retrieved from the user's computer; retrieving a permission parameter set from storage in association with the verification server that governs what personal information is collectible from the user; and transmitting to an Internet site identified in the Internet site request a permission parameter based upon the permission parameter set that governs what personal information about the user may be collected.

Yet another aspect of the present invention relates to a method for determining whether personal information may be collected from a computer user comprising the steps of: transmitting an Internet site request containing at least a computer identifier from a users computer to a first Internet server; redirecting the Internet site request to a second Internet server; determining a personal identifier associated with the user at the second Internet server utilizing the computer identifier; transmitting the personal identifier associated with the user to the first Internet server; storing the personal identifier associated with the user on the first Internet server; transmitting a site identifier associated with the requested Internet site, and transmitting the user's personal identifier to a third Internet server; retrieving a permission parameter set associated with the user utilizing the user's personal identifier, at the third Internet server; determining whether the requested Internet site is authorized to receive personal information about the user based upon the permission parameter set established for the user and based upon the site identifier; and transmitting personal information about the user to the first Internet server, based upon the permission parameter set and the site identifier.

Another aspect of the present invention relates to a method for determining whether personal information may be collected from a computer user comprising the steps of: receiving a redirected Internet site request containing at least a computer identifier at an Internet server; determining a personal identifier associated with the user at the Internet server utilizing the computer identifier; transmitting the personal identifier associated with the user to the Internet site requested by the user; receiving a site identifier associated with the Internet site requested by the user and the personal identifier associated with the user; determining whether the requested Internet site is authorized to receive personal information about the user, and determining what personal information the Internet site is authorized to receive, based upon a permission parameter set established for the user; and transmitting personal information about the user to the first Internet server, based upon the permission parameter set.

Another aspect of the present invention relates to a computer-readable medium bearing instructions for determining whether personal information can be collected from a computer user, said instructions, when executed, are arranged to cause a computer system to perform the steps of: receiving a redirected Internet site request containing at least a computer identifier at an Internet server; determining a personal identifier associated with the user at the Internet server utilizing the computer identifier; transmitting the personal identifier associated with the user to the Internet site requested by the user; receiving a site identifier associated with the Internet site requested by the user and the personal identifier associated with the user; determining whether the requested Internet site is authorized to receive personal information about the user, and determining what personal information the Internet site is authorized to receive, based upon a permission parameter set established for the user; and transmitting personal information about the user to the first Internet server, based upon the permission parameter set.

Yet another aspect of the present invention relates to a computer-readable medium bearing instructions for determining whether personal information can be collected from a computer user, said instructions, when executed, are arranged to cause a computer system to perform the steps of: storing at a centralized location permission parameters defined by a person having authority to establish a permission parameter set for the user that govern collection of personal information regarding the user; retrieving permission parameters associated with a user when the user accesses an Internet site; determining whether the Internet site is able to obtain personal information from the user based upon the user's permission parameters; and obtaining personal information about the user at the Internet site based upon the determination whether the Internet site is able to obtain personal information about the user.

Yet another aspect of the present invention relates to a computer-readable medium bearing instructions for determining whether personal information can be collected from a computer user, said instructions, when executed, are arranged to cause a computer system to perform the steps of: receiving a redirected Internet site request at a verification computer; retrieving data from the user's computer by the verification computer; determining whether the computer user is older than a predetermined age based upon the data retrieved from the user's computer; retrieving a permission parameter set that governs what personal information is collectible from the user; and transmitting to an Internet site identified in the Internet site request a permission parameter based upon the permission parameter set that governs what personal information about the user may be collected.

Yet another aspect of the present invention relates to a method for determining whether personal information may be collected from a computer user accessing an Internet site comprising the steps of receiving a uniform resource locator (URL) request from a computer user at an Internet server; redirecting the computer user to a second Internet server to effectively request permission to collect personal information from the computer user; receiving at least a permission parameter that indicates what personal information may be collected from the computer user; and collecting personal information from the computer user indicated as collectible by the at least a permission parameter.

Still another aspect of the present invention relates to a method for determining whether personal information may be collected from a computer user accessing an Internet site comprising the steps of: receiving a uniform resource locator (URL) request containing a computer identifier from a computer user at an Internet server; establishing a communication connection with a second Internet server; passing the computer identifier to the second Internet server over the communication connection; passing a site identifier associated with the URL to the second Internet server over the communication connection; requesting permission to receive personal information about the computer user from the second Internet server; and receiving personal information from the second Internet server about the computer user indicated as releasable by a permission parameter set established for the computer user.

Yet another aspect of the present invention relates to a method for determining whether personal information may be collected from a computer user accessing an Internet site comprising the steps of: transmitting a uniform resource locator (URL) request; logging on to an Internet server that contains a permission parameter set that governs collection of personal information from the computer user; and accessing the requested URL wherein personal information gathered resulting from the computer user's access to the requested URL is controlled by the permission parameter set.

Yet another aspect of the present invention relates to a method for determining whether personal information may be collected from a computer user accessing an Internet site comprising the steps of: transmitting a uniform resource locator (URL) request to an Internet server; transmitting information related to age validation to a second Internet server; transmitting information used to establish a permission parameter set for governing collection of personal information from the computer user to the second Internet server; and accessing the requested URL on the first Internet server wherein personal information gathered resulting from the computer user's access to the requested URL is controlled by the permission parameter set.

The methods of the present invention may be implemented in any suitable conventional manner including, without limitation, via the use of an apparatus or computer communicating with a web server and another computer or web server.

Additional aspects, technical effects, embodiments and advantages of the present invention will be set forth, in part, in the description that follows, or may be learned from practicing or using the present invention. The objects, advantages or technical effects may be realized and attained by computer-implemented means as exemplified by the features and combinations particularly pointed out throughout this description and the appended claims. It is to be understood that the foregoing general description and the following detailed description are exemplary and explanatory only and are not to be viewed as being restrictive of the invention as claimed. For instance, while the present invention is described in the context of compliance with COPPA legislation, it is not limited to such use or legislation.

### BRIEF DESCRIPTION OF THE DRAWINGS

The accompanying drawings, which are incorporated in and constitute a part of the specification, illustrate embodiments of the present invention and, together with the description, serve to exemplify the principles of the present invention.

FIG. 1 shows a configuration of computers and Internet servers utilized with an embodiment of the present invention.

FIG. 2 shows a transaction according to the embodiment of the present invention depicted in FIG. 1.

FIG. 3 shows a verification server process according to the embodiment of the present invention depicted in FIG. 1.

FIG. 4 shows a web server process according to the embodiment of the present invention depicted in FIG. 1.

FIG. 5 shows a table arrangement utilized with the embodiment of the invention shown in FIG. 3.

FIG. 6 shows a table arrangement utilized with the embodiment of the invention shown in FIG. 3.

FIG. 7 shows a configuration of computers and Internet servers utilized with a second embodiment of the present invention.

FIG. 8 shows a transaction according to the embodiment of the present invention depicted in FIG. 7.

FIG. 9 shows a web server process according to the embodiment of the present invention depicted in FIG. 7.

FIG. 10 shows a logon server process according to the embodiment of the present invention depicted in FIG. 7.

FIG. 11 shows an information server process according to the embodiment of the present invention depicted in FIG. 7.

FIG. 12 shows a database arrangement according to the embodiment of the present invention depicted in FIG. 7.

FIG. 13 shows an exemplary computer system capable of implementing the present invention.

FIGS. 14 & 15 show an exemplary web page for configuring a permission parameter set for an Internet user.

### DETAILED DESCRIPTION OF PREFERRED EMBODIMENTS

The present invention solves the above-described and other technical problems by providing a method, apparatus, and software for establishing a permission parameter set associated with each individual computer user who accesses the Internet. Each computer user is associated with a permission parameter set that is either established by the computer user herself, or by a guardian or other person in a supervisory position. When a computer user accesses the Internet after a permission parameter set associated with the computer user has been established, the computer user's permission parameter set is utilized by web sites and online services, and governs collection of personal information about the individual computer user on a transaction-by-transaction basis as the computer user accesses various web sites and online services.

Utilization of a permission parameter set associated with each computer user who accesses the Internet allows web sites and online services to receive and/or obtain personal information from each computer user that is automatically verified as personal information that either the computer user or a guardian or other person in a supervisory position has authorized web sites and online services to have access to. Permission parameter sets allow access to authorized personal information without requiring a computer user or guardian or other person in a supervisory position to specifically grant or deny permission to collect personal information each time a web site or online service is accessed by a computer user. Permission parameter sets also allow customization of what personal information is collected by various web sites and online services depending upon the type of web site or online service, what the web site operator or online service intends to do with the personal information, etc.

Internet Cookie Overview

Several embodiments of the invention utilize a cookie placed onto a computer user's computer. Before describing those embodiments, a brief explanation of what constitutes a cookie is given. “Cookie” is a term used to refer to an Internet mechanism that allows web servers to place information onto a computer that accesses a Uniform Resource Locator (URL), the address of a web site, residing on the web server. A cookie is placed into permanent memory, i.e., onto a hard drive, and is stored on the computer even after the Internet session between the computer and web server has ended. When the computer is used to access the Internet again, and the same URL is accessed, the web server retrieves the information stored in the cookie on the computer's hard drive and passes the information to the computer hosting the URL. Only a web server that places a particular cookie onto a computer may later retrieve that particular cookie and access the information contained in the cookie. See Newton's Telecom Dictionary, 12th Ed. (1997).

Overview of Embodiments Utilizing a Cookie

According to embodiments of the present invention, when an Internet user establishes communication with a web site or online service, the server hosting the web site or online service, e.g., a web server, attempts to retrieve a permission parameter and an identifier, both associated with the particular Internet user, from the URL request transmitted to the server from the Internet user's computer. However, if there is no permission parameter or identifier in the transmitted URL request, the Internet user's URL request is redirected to a verification server. The redirected URL request contains at least the requested URL and a site identifier associated with the web site or online service.

Upon redirection of the Internet user's URL request, the verification server attempts to retrieve a verification cookie from the Internet user's computer. If a verification cookie is retrieved, information in the verification cookie is utilized by the verification server to inform the web server whether the Internet user is an adult, to prompt the Internet user to logon to the verification server, or to retrieve a profile associated with the particular Internet user, depending upon the configuration of the Internet user's computer and the age of the Internet user.

If the verification cookie indicates that the Internet user is an adult, a permission parameter and identifier, extracted from the verification cookie, are transmitted from the verification server to the web server without requiring the Internet user to logon to the verification server and/or without retrieving a permission parameter set. If the verification server either automatically retrieves a permission parameter set, or requires the Internet user to logon and perform an age validation before retrieving or creating a permission parameter set, the verification server subsequently transmits a permission parameter and identifier associated with the particular Internet user, extracted from the permission parameter set associated with the Internet user, to the web site or online service. The web site or online service then utilizes the permission parameter and identifier to regulate what personal information is collected from the user.

However, if no verification cookie is retrieved from the Internet user's computer by the verification server, the Internet user is prompted either to validate as an adult, or to indicate that the user is a minor. In certain embodiments, validation as an adult allows the Internet user to access the requested web site or online service, and causes the verification server to pass a permission parameter indicating that there are no limits restricting what personal information the web site or online service may collect from the Internet user. The verification server may also pass an identifier to the web site or online service indicating that the Internet user is an adult. A cookie is stored on the Internet user's computer by the verification server.

In certain other embodiments, validation as an adult results in the verification server prompting the Internet user to create a permission parameter set that is used to govern what personal information web sites and online services may collect from the Internet user. In such an instance, the verification server queries for and receives a site identifier from the web site or online service. Based upon the site identifier and the Internet user's newly created permission parameter set, the verification server passes a permission parameter indicating what restrictions exist regarding collection of personal information from the Internet user to the web site or online service. A cookie is also stored on the Internet user's computer by the verification server.

Indicating that the Internet user is a minor further prompts the Internet user to have an adult undergo age validation with the verification server. Once an adult has verified her age with the verification server, the adult is prompted to establish a profile for the minor Internet user. While establishing the minor Internet user's profile, the adult specifies the permission parameters in the permission parameter set associated with the minor Internet user and how the permission parameter set is to be applied to different types of web sites or online services, for example, based upon the type of information the web site or online service collects and what actions the web site or online service takes with the collected information. Another example is to classify web sites and online services into categories and have the adult grant or deny information collection permission for the various categories. As recognized by one of ordinary skill in the art, other methods for specifying how to grant or deny permission may be used with the present invention to establish permission parameter sets.

Once the minor Internet user 's permission parameter set has been established, the minor Internet user is granted access to the web site or online service, and the verification server transmits a permission parameter and an identifier associated with the minor Internet user to the web site or online service. In subsequent Internet transactions, web sites and online services required to comply with COPPA receive automated, parental permission based upon the minor Internet user 's permission parameter set as described supra.

Non-multiuser Operating System Embodiment

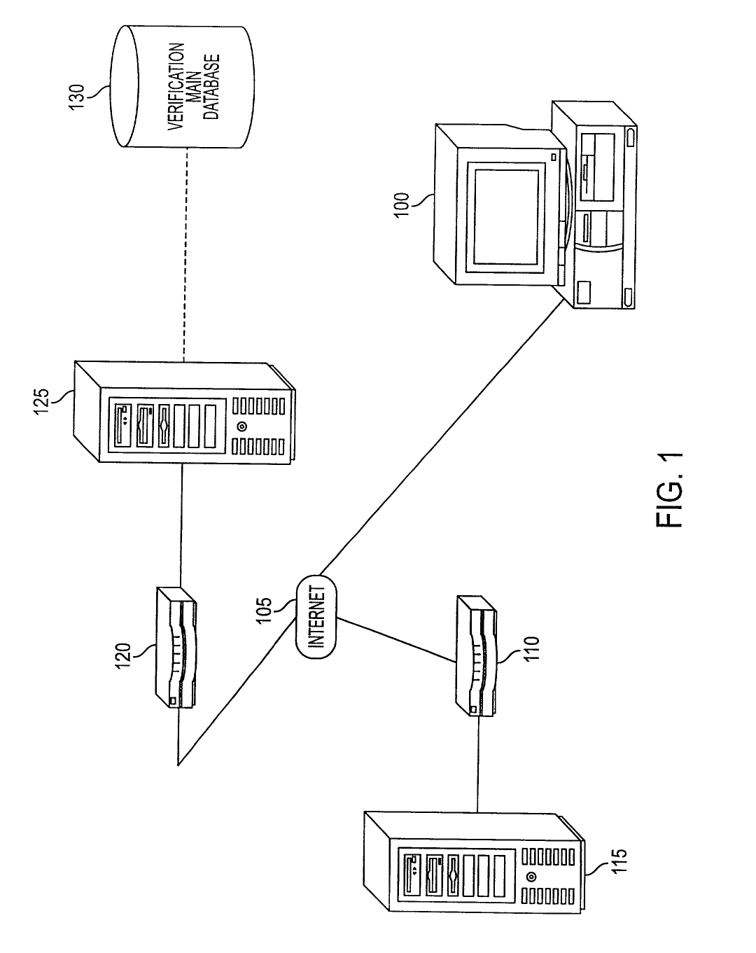

FIGS. 1, 3, and 4 are referred to in the following description of an embodiment of the present invention enabling verification of permission to collect personal information complying with COPPA when an Internet user is at a computer running an operating system that does not distinguish between multiple users. Referring to FIG. 1, a computer system 100 is utilized to connect to the Internet 105, for example, to a web site or online service (not shown in the drawing) maintained and operated on a web server 115. Computer system 100 does not support multiple user accounts, i.e., there is no manner of distinguishing one computer user from another when computer system 100 is utilized. For example, if computer system 100 is running a Macintosh™ operating system, a palmtop operating system, or a Microsoft Windows™ operating system such as Windows3.1™, an Internet user is not required to logon to computer system 100 in order to operate the computer system 100. By not requiring an Internet user to logon to computer system 100, computer system 100 receives no data useful for distinguishing one Internet user from another. The same scenario also occurs for operating systems such as Microsoft Windows95™, Windows98™, WindowsME™, and WindowsCE™ that are capable of being configured to logon multiple users, and therefore differentiate between the Internet users, but are not so configured.

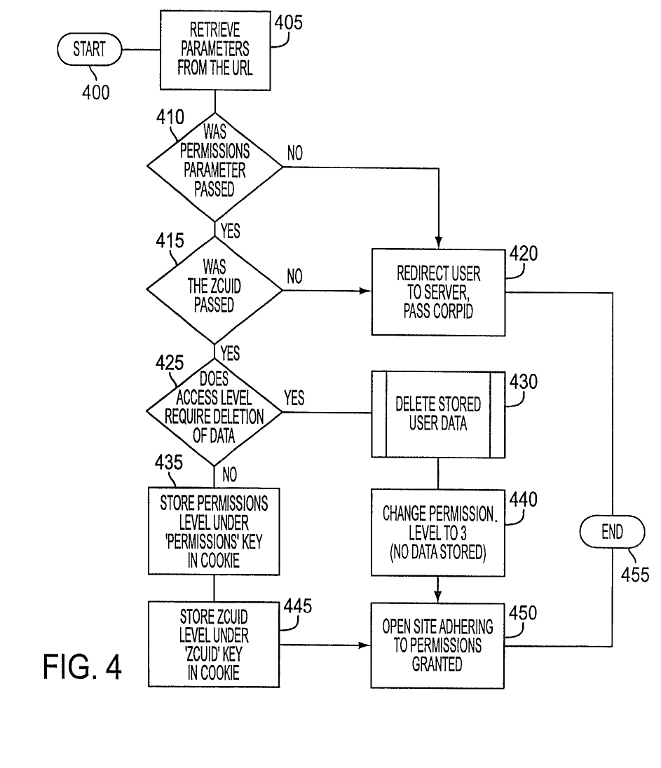

An Internet user at computer system 100 accesses the Internet, for example, by utilizing a web browser running on computer system 100. A request for a URL is transmitted from computer system 100 to the Internet, e.g., to a web server 115. A request for access to a URL is not limited to transmission to a web server 115, but can be transmitted to any computer or computer system communicating with the public packet switched network commonly known as the Internet. A web server script or other program, for example one following the processing flow detailed in FIG. 4, runs on server 115 on the first, or default, page of the web site or online service associated with the requested URL. The present invention is not limited to a script running on a single web server for a single URL. A web server script, or other program, may be implemented through a variety of web servers utilizing some form of common gateway interface scripting, or other manner for associating plural web servers with plural URLs.

When the URL request reaches web server 115, step 400 in FIG. 4, the web server script retrieves data from the URL request at step 405. However, a URL request from computer system 100 does not contain a permission parameter, therefore the determination at step 410 indicates that no permission parameter was received. No permission parameter was passed to the web server 115, therefore, the web server script proceeds to step 420, and redirects the URL request to a verification server 125. Before the web server 115 redirects the URL request to the verification server 125, at least a site identifier associated with the web site operator or online service is appended to the URL request that was received from the Internet user's computer 100. The web server 115 redirects the Internet user's URL request by transmitting the original URL request, now containing at least a site identifier, to the verification server 125.

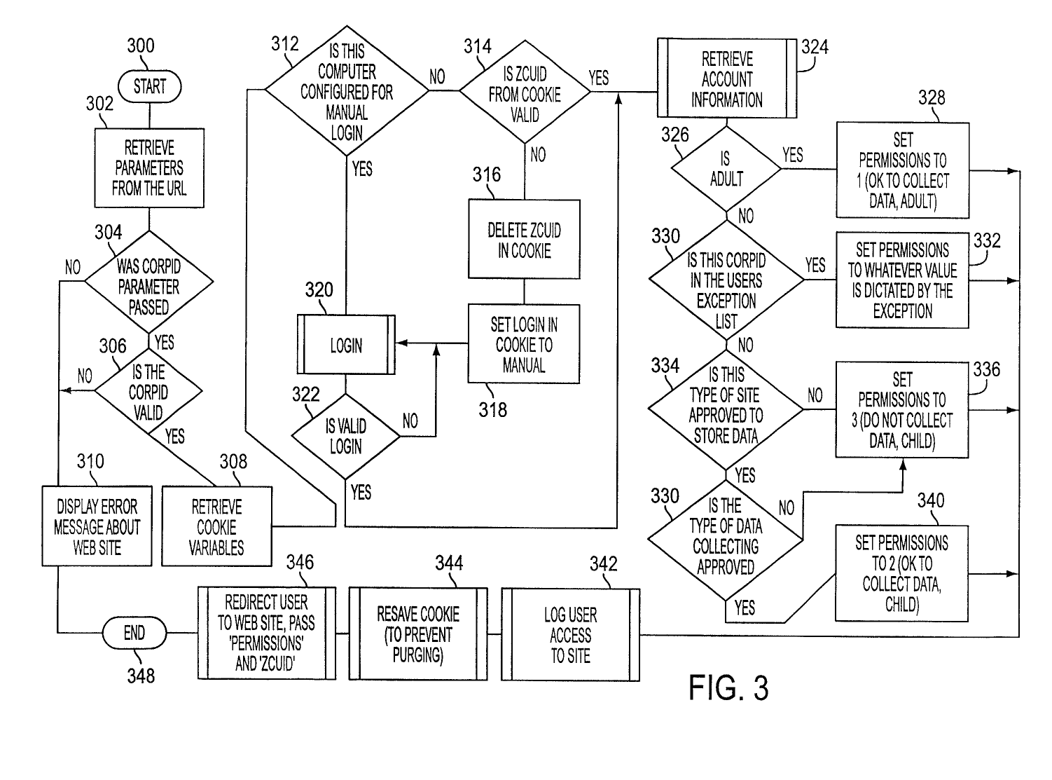

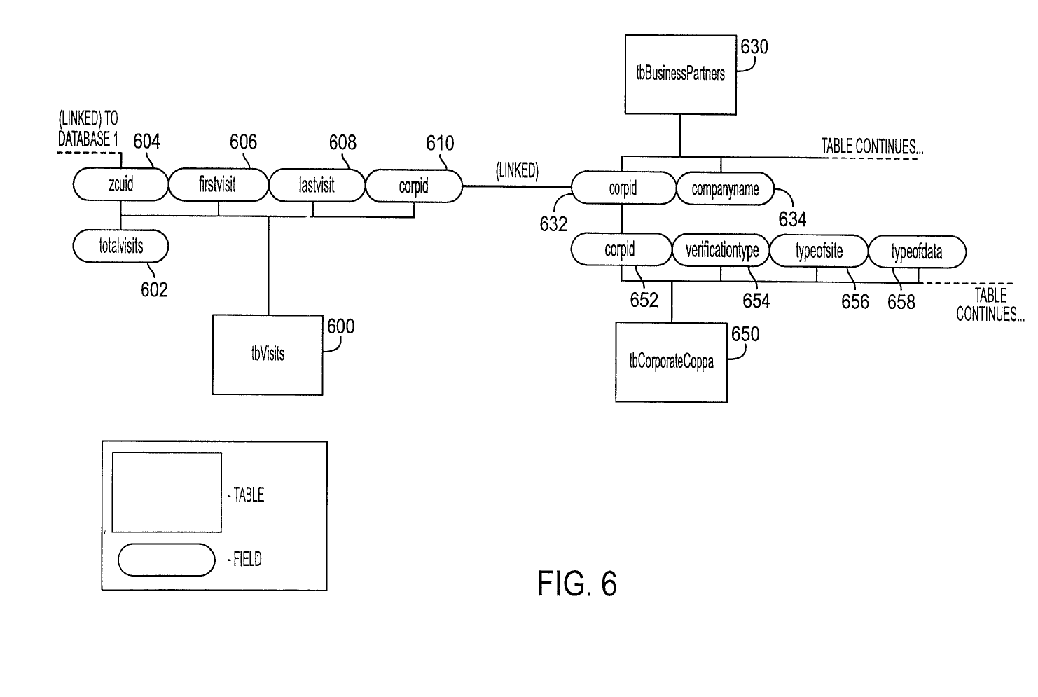

The redirected URL request is received by a verification server 125 at step 300, FIG. 3, and a verification server process retrieves data, for example, the site identifier associated with the web site operator or online service, from the URL request at step 302. A determination of whether a site identifier, for example corpid 632 in table 630 (FIG. 6), was attached to the URL request is made at step 304. If no site identifier was passed, an error message indicating that the site does not participate in the personal information verification service is displayed at computer system 100 at step 310, for example, by transmitting a browser page from verification server 125 to the Internet user's computer system 100 or other manner for causing a message to be displayed on a computer system 100 connected to the Internet, and processing on the verification server 125 ends at step 348.

However, a web site or online service utilizing the verification server 125 normally transmits a site identifier, and processing at the verification server 125 proceeds from step 304 to step 306. At step 306 a database query is performed to verify that the transmitted site identifier is valid. For example, verification server 125 queries the business partners table 630 (FIG. 6) for a match between the transmitted site identifier and an identifier contained in a corpid field 632. If no match is found between the transmitted site identifier and an identifier contained in a corpid field 632, then an error message is displayed on computer system 100 at step 310, for example by transmitting a browser window or other manner for causing a message to be displayed on a computer system 100 connected to the Internet, and processing ends at step 348.

After the transmitted site identifier is validated at step 306, the verification server 125 retrieves its cookie from computer system 100. If the verification server 125 does not have a cookie on computer system 100, the Internet user must perform an age validation that establishes a permission parameter indicating that personal information can be collected from the Internet user, if the Internet user is over 13 years of age. The age validation process is described in detail infra. If the Internet user is not over 13 years of age, then a permission parameter set must be created for the Internet user in order to establish a permission parameter that is automatically transmitted to a web site or online service requesting permission to collect personal information from the Internet user. Creation of a permission parameter set is a one-time occurrence for each Internet user, described in detail infra. After an Internet user's permission parameter set has been created, the permission parameter set is used to determine whether a web site or online service is able to collect personal information from the particular Internet user associated with the permission parameter set, as described below. After a permission parameter set has been created, the verification server 125 stores a cookie on computer system 100. At step 312 a determination is made that computer system 100 is configured for manual login (because the computer system 100 is not capable of supporting distinct user accounts). Another situation that results in a determination that computer system 100 is configured for manual login is when this is the first time that an Internet user at computer system 100 has been redirected to verification server 125, and there is therefore no cookie for verification server 125 to retrieve.

Processing continues at step 320 where the Internet user at computer system 100 is prompted to login to the verification server 125. For example, an Internet user is presented with a browser page transmitted from the verification server 125 that has fields for a username and password. Once the Internet user fills in the fields and clicks on a button, the logon information is transmitted back to the verification server 125. If the Internet user does not have a permission parameter set stored on database 130, the Internet user establishes a permission parameter set, establishing a permission parameter set is described in detail infra, including age validation, at step 320. For Internet users that do have a permission parameter set stored in database 130, a determination is made at step 322 whether the login from step 320 is valid. If the logon information from step 320 is not valid, then the Internet user at computer system 100 is prompted to logon again.

After validating the Internet user's logon, the verification server 125 continues processing at step 324 where a pre-existing permission parameter set is retrieved based upon the logon information received at step 320. Once the Internet user's permission parameter set has been retrieved, a determination is made at step 326 whether the Internet user is an adult, i.e., is over the age of 13.

If the Internet user is an adult, then the permission parameter is set to reflect that the Internet user is more than 13 years of age at step 328, thus indicating that collection of personal information from the Internet user is allowed. Optionally, a record of the Internet user's access to the URL is logged at step 342. The Internet user is redirected to the web site or online service associated with the requested URL at step 346. When the Internet user is redirected to the web site or online service, the permission parameter associated with the Internet user and a user identifier are passed to the web server 115. At step 344 the verification server 125 saves, or resaves, its cookie on computer 100. Saving and resaving the verification server's cookie on computer 100 prevents computer 100 from purging the cookie by resetting the 90 day limit established for a cookie to remain on a computer.

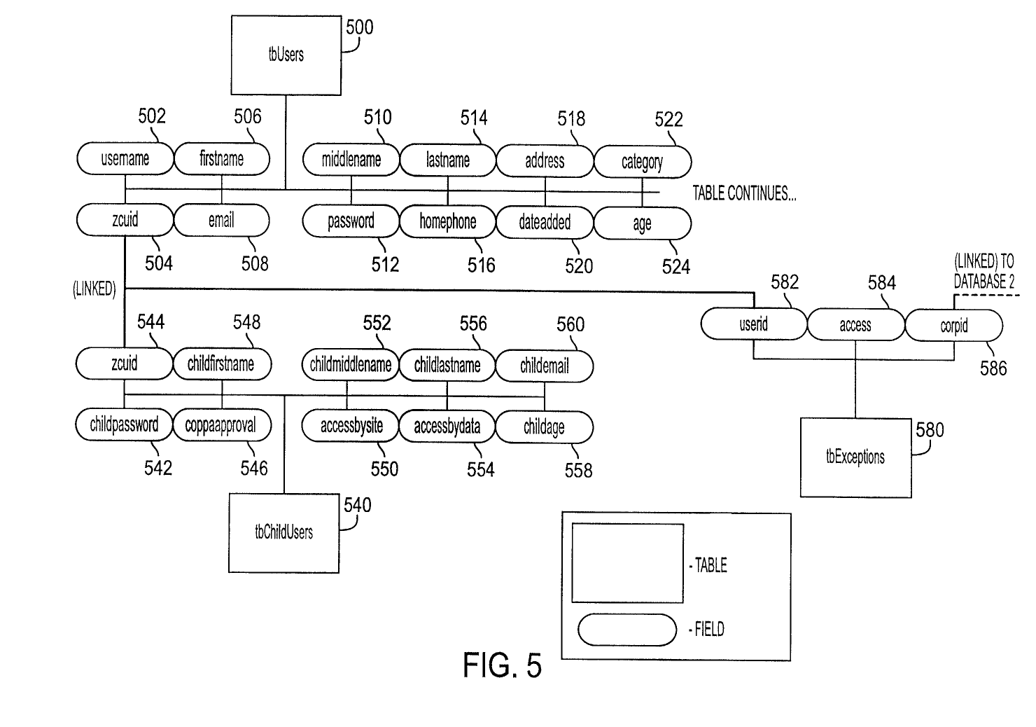

If the Internet user does not validate as an adult at step 326, then a determination is made at step 330 whether the transmitted site identifier is on an exception list. For example, the verification server 125 performs a database query for the transmitted site identifier on table 580 (FIG. 5), and the permission parameter is set to reflect the exception in step 332 if the transmitted site identifier is on the exception list. For example, the exception list includes exceptions defined in the COPPA legislation, such as a one-time request by a child for “homework help.” If the transmitted site identifier is not on the exception list, then a determination is made at step 334 whether the web site or online service is approved to collect and store data from the minor Internet user based upon the minor Internet user's permission parameter set. Alternatively, or as a supplemental approval validation, a determination may be made at step 338 whether the type of data collecting performed by the web site or online service is allowed, regarding collection of personal information from the minor Internet user based upon the minor Internet user's permission parameter set. As one of ordinary skill in the art will recognize, other manners for determining whether a web site or online service has permission to collect personal information from a minor Internet user can be utilized with the present invention.

If the verification server 125 does not approve personal information data collection by the web site or online service based upon the minor Internet user's permission parameter set, then the permission parameter transmitted from the verification server 125 is set to reflect that there is no permission to collect and store information from the minor Internet user at step 336. However, if the web site or online service is approved to collect personal information, then the permission parameter transmitted from the verification server 125 is set to reflect that the web site operator or online service may collect personal information from the minor Internet server. Various levels of permission for various types of web sites and online services may exist in a single minor's permission profile. Accordingly, depending upon the type of web site or online service, permission to collect personal information from a minor ranges from no permission; to limited permission, e.g., permission to collect generic data such as gender, age, and zip code; and so on up to full permission, e.g., permission to collect data such as name, address, and social security number (SSN). To be compliant with COPPA, one permission level indicates that not only can personal information not be collected from a minor, but any previously collected personal information must be deleted.

The foregoing example is meant to describe the present invention in an exemplary manner, and is not limiting as to how verification of parental permission is determined. One of ordinary skill in the art will recognize numerous manners for verifying parental permission commensurate with the scope of the present invention.

A record of the minor Internet user's access to the URL is logged at step 342, and the minor Internet user's Internet session is redirected to the web site or online service associated with the requested URL at step 346 after the verification server 125 has saved a cookie on the minor Internet user's computer 100. For example, redirecting the minor Internet user's Internet session is accomplished by appending a permission parameter to the URL request that the verification server 125 received from the web server 115. The verification server 125 then transmits the URL request back to the web server 115 so that the minor Internet user is now interacting with web server 115 instead of interacting with verification server 125. At step 344, saving or resaving the verification server's cookie on computer 100 prevents computer 100 from purging the cookie by resetting the 90 limit that a cookie can remain on a computer without being purged. When the minor Internet user's Internet session is redirected to the web site or online service, the permission parameter and the minor Internet user's user identifier are transmitted to the web server 115.

Additionally, for determining and/or maintaining the status of a user's logon session, a session variable associated with the Internet user may be stored on the verification server 125 during the Internet user's Internet session after the Internet user has logged onto the verification server 125. The verification server stores information about the Internet user in the session variable, and associates the information with the Internet user's computer 100. When the Internet user accesses another internet site or online service that requires COPPA verification, the Internet user's Internet session is redirected to the verification server 125 again, but the verification server 125 “remembers” the Internet user because of the information in the session variable. The Internet user's Internet session is automatically redirected back to the new web site or online service with a permission parameter from the session variable stored on the verification server 125. The session variable expires when the Internet user's Internet session ends. The session variable stored on the verification server 125 could also, for example, expire after a set period of time in order to prevent other persons from utilizing the Internet user's computer 100 while the computer 100 is associated with the original Internet user's logon information. Embodiments utilizing session variables are discussed in more detail infra. It should be noted that a skilled artisan may use other logon monitoring methods to determine and/or maintain the status of a user logon (e.g., using session variables associated with cookies that store variable values and be a variable itself.

Multi-user Operating System Embodiment

The present invention also utilizes a web server's ability to distinguish between different Internet users when the Internet users connect to the Internet utilizing a computer system running an operating system that differentiates between multiple users. Many computer operating systems operate in multiple user modes, and are capable of associating an Internet cookie with each individual Internet user who has an account with the operating system. When an Internet user accesses the Internet from a computer running an operating system that operates in multiple user mode, web servers that the Internet user accesses during an Internet session create cookies that are associated with that particular Internet user's account on the computer. For example, on a computer system running Microsoft Windows NT™ a separate account is created for each Internet user that utilizes the computer system, and a web server is able to store multiple cookies on the computer. Each cookie is associated with a different Internet user's account on the computer system.

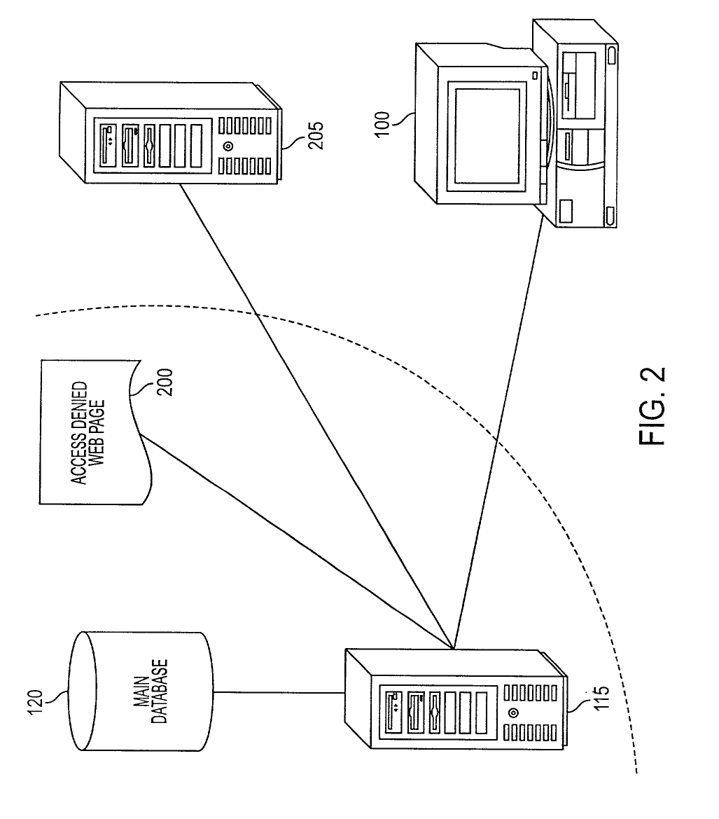

Adverting to FIG. 2, an Internet user at computer system 200 accesses the Internet, for example, by utilizing a web browser running on computer system 200. Computer system 200 is configured to differentiate between multiple Internet users by requiring each Internet user to enter a unique name and password before using computer system 200. A request for a URL is transmitted from computer system 200 to the Internet, e.g., to a web server 115. A request for access to a URL is not limited to transmission to a web server 115, but can be transmitted to any computer or computer system communicating with the Internet. A web server script or other program, for example one following the processing flow detailed in FIG. 4, runs on server 115 for the first, or default, page of the web site or online service associated with the requested URL. However, the present invention is not limited to running a script on a single web server for a single URL. A web server script, or other program, may be implemented through a variety of web servers utilizing some form of common gateway interface scripting, or other manner for associating plural web servers with plural URLs.

When the URL request reaches web server 115, step 400 in FIG. 4, the web server script retrieves data from the URL request at step 405. However, a URL request from computer system 200 does not contain a permission parameter, therefore the determination at step 410 indicates that no permission parameter was received.

Because no permission parameter was passed to the web server 115, the web server script proceeds to step 420, and redirects the URL request, for example, as described supra, to a verification server 125. When the web server 115 redirects the URL request to the verification server 125, a site identifier associated with the web site operator or online service is appended and transmitted along with the redirected URL request.

The redirected URL request is received by a verification server 125 at step 300, FIG. 3, and a verification server process retrieves data, for example, the site identifier associated with the web site operator or online service, from the URL request at step 302. A determination of whether a site identifier, for example corpid 632 in table 630 (FIG. 6), was attached to the URL request is made at step 304. If no site identifier was passed, then an error message is displayed at computer system 100 at step 310, for example by transmitting a browser page from the verification server 125 to computer system 200, and processing on the verification server 125 ends at step 348.

However, a web site or online service utilizing the verification server 125 normally transmits a site identifier, and processing at the verification server 125 proceeds from step 304 to step 306. At step 306 a database query is performed to verify that the transmitted site identifier is valid. For example, verification server 125 queries the business partners table 630 (FIG. 6) for a match between the transmitted site identifier and an identifier contained in a corpid field 632. If no match is found between the transmitted site identifier and an identifier contained in a corpid field 632, then an error message is displayed, via a browser page from verification server 125 or other Internet mechanism, on computer system 200 at step 310 and processing ends at step 348.

After the transmitted site identifier is validated at step 306, the verification server 125 retrieves its cookie from computer system 200. Once a verification cookie has been retrieved, the verification server 125 extracts data from the verification cookie, for example, the Internet user's verification identifier and permission parameter. However, if the verification server 125 does not have a cookie on computer system 200 the Internet user must perform an age validation. Depending upon the validated age, the Internet user may be required to establish a permission parameter set. The age validation process and establishing a permission profile are described in detail infra. After age validation and/or permission parameter set creation, the verification server 125 stores a cookie on computer system 200.

At step 312 a determination is made that computer system 200 is not configured for manual login (because the computer system 200 supports distinct user accounts), and processing continues at step 314, where a determination is made whether the Internet user's verification identifier is valid. For example, the verification server 125 performs a database query on table 500 (FIG. 5) and checks for a match between the Internet user's verification identifier retrieved from the verification cookie and an identifier in a zcuid field 504. If the Internet user's verification identifier does not validate, then the Internet user's verification identifier is removed from the verification cookie at step 316, and the cookie is set to indicate manual logon at step 318. The Internet user at computer system 200 is prompted to login to the verification server 125 at step 320, for example via a browser page transmitted from the verification server 125 containing fields for the Internet user to enter a username and password. After the Internet user enters a username and password, and clicks on a button, the username and password are transmitted to the verification server 125. As recognized by one of ordinary skill in the art, other manners of logging the Internet user onto the verification server 125 may be utilized with the present invention.

After validating the Internet user's verification identifier at step 314, or validating the Internet user's logon at step 322, the verification server 125 continues processing at step 324 where a pre-existing permission parameter set is retrieved based upon the Internet user's verification identifier. Note that the pre-existing permission parameter set was recently created and stored on database 130 if the Internet user is a new user and was required to establish a permission parameter set at step 320. The process of establishing a permission parameter set is described in detail, infra. Once the Internet user's permission parameter set has been retrieved, a determination is made at step 326 whether the Internet user is an adult, i.e., is over the age of 13. Processing from step 324 to step 348 is identical to the processing described in relation to a non-multi user system, supra.

Creating a Permission Parameter Set for Multiuser and Non-Multiuser Embodiments

Establishing a permission parameter set is described referring to FIGS. 2, 3 and 5. The first time an Internet user's Internet session is redirected to a verification server 115, as described supra, there is no verification cookie associated with the Internet user for the verification server 115 to retrieve. A computer 200 is considered to be redirected to a verification server 115 for the first time when there is no cookie created by verification server 115 residing on the computer 200 associated with the Internet user's account on computer 200. Likewise, a computer 100 (FIG. 1) that does not support multiple users is regarded as redirected to a verification server 115 for the first time when there is no cookie created by the verification server 115 stored on computer 100.

When no verification cookie is retrieved at step 308 (FIG. 3), a “yes” determination is made at step 312 and the verification server 115 prompts the user at computer 200 to enter identifying information at the logon step, 320. For example, the Internet user is prompted via a browser page transmitted from the verification server 125 containing fields for the Internet user to enter a username and password. The Internet user enters the appropriate information and then transmits the data to the verification server by clicking on a button. The browser window displayed on the user's computer 200 at step 320 may also contain a field, where information entered into the field indicates that creation of a new permission parameter set is necessary. A new Internet user who does not have a username and password must create a permission parameter set in order to continue. Other manners of initiating permission parameter set creation are possible, and are consistent with the present invention.

When creating a new permission parameter set, an Internet user is prompted via a message sent by verification server 125 to enter whether they are older than 13 years of age, or 13 years of age or younger. By way of example and not limitation, a browser window containing two buttons and prompting the Internet user to click the appropriate button could be used, or a window containing a field where the Internet user enters an age could be used. If an Internet user indicates an age older than 13 years, an age validation process occurs.

An age validation process is, for example, a credit card check where the verification server 125 transmits a browser window containing fields for a credit card number and relevant information such as the name on the credit card, billing address of the credit card, expiration date of the credit card, etc. The Internet user supplies the required data and clicks on a button to transmit the data to the verification server 125. The verification server 125 then, for example, attempts to authorize a purchase on the credit card by transmitting the data supplied by the Internet user to the company that issued the credit card. If a purchase is authorized, then the credit card and relevant information are considered authorized and the Internet user is validated as the owner of the credit card and therefore an adult because of the credit card laws. Other examples include utilizing an Internet user's social security number, driver's license, digital signature, fax/mail form submission, voice verification, or other data considered private to the Internet user.

If the age verification process validates that the Internet user is over 13 years of age, then no permission parameter set needs to be created for the Internet user. Instead, the verification server 115 creates a cookie containing a permission parameter that indicates that the Internet user is an adult. The verification server 115 then stores the cookie on computer 200 so that the cookie is associated with the particular Internet user, i.e., the user's account on computer 200. In future transactions with the verification server 125, the cookie stored on computer 200 associated with the Internet user is retrieved by the verification server 125, and the permission parameter is recognized as indicating that the Internet user is an adult. The permission parameter and a generic user verification identifier are then passed to a web site or online service to indicate that the Internet user is an adult, therefore personal information may be collected.

However, there is a need to create a permission parameter set for an adult if the adult is accessing the Internet with a computer that is not capable of distinguishing between multiple users, for example computer 100. By way of example and not limitation, a simplified permission parameter set containing a username 502, a password 512, and a permission parameter 522 is created for the Internet user. The Internet user's permission parameter set is then utilized to inform web sites and online services that personal information may be collected from the Internet user. An alternative to retrieving the Internet user's permission parameter set for every access to a web site or online service is to temporarily store the Internet user's permission parameter on computer 100, for example in a cookie that is removed when the Internet session ends. Alternatively a session variable as described infra may be utilized.

There is also a need to create a permission parameter set for an adult if the adult does not desire her personal information to be freely collected by web sites and online services. In this instance, a permission parameter set is created by the Internet user and utilized in the same manner as a permission parameter set that governs what personal information can be collected from a minor Internet user, as described below.

If the age verification process results in a determination that the Internet user at computer 200 is not over 13 years of age, then a message, indicating that adult permission is required before a requested URL can be accessed, is displayed, for example via a browser page transmitted from the verification server 125 to computer 200. An adult logon window is displayed on computer 200, for example via a browser page transmitted from the verification server 125 to the computer 200, for an adult to enter identifying information. After identifying information is entered into the adult logon window and transmitted to the verification server 125, an age validation, as described supra, occurs to verify that the information indicates that an adult is present at computer 200. If the adult's identifying information does not validate, the adult logon window is redisplayed, utilizing the same manner as before, at computer 200.

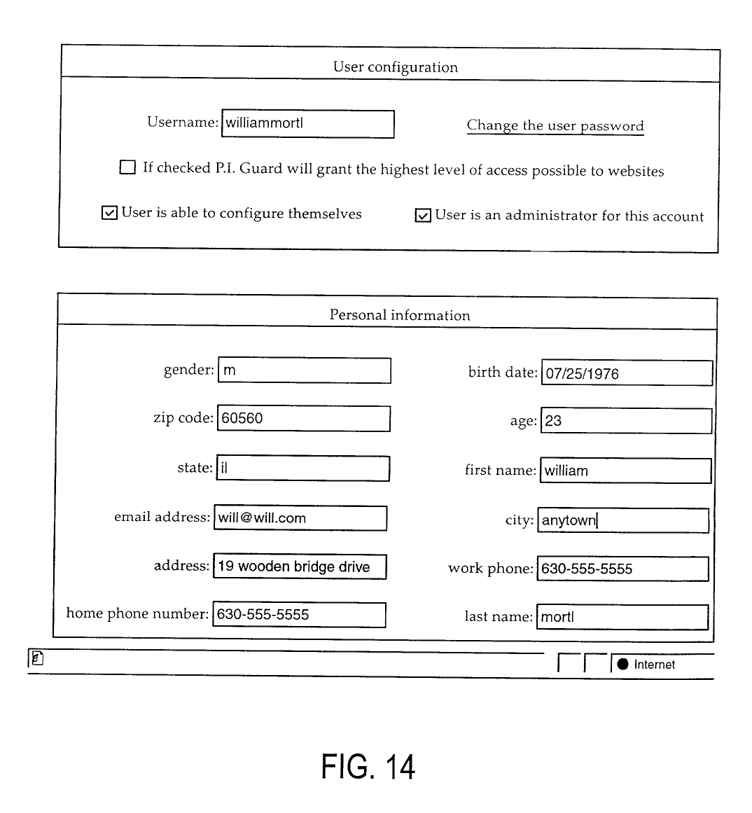

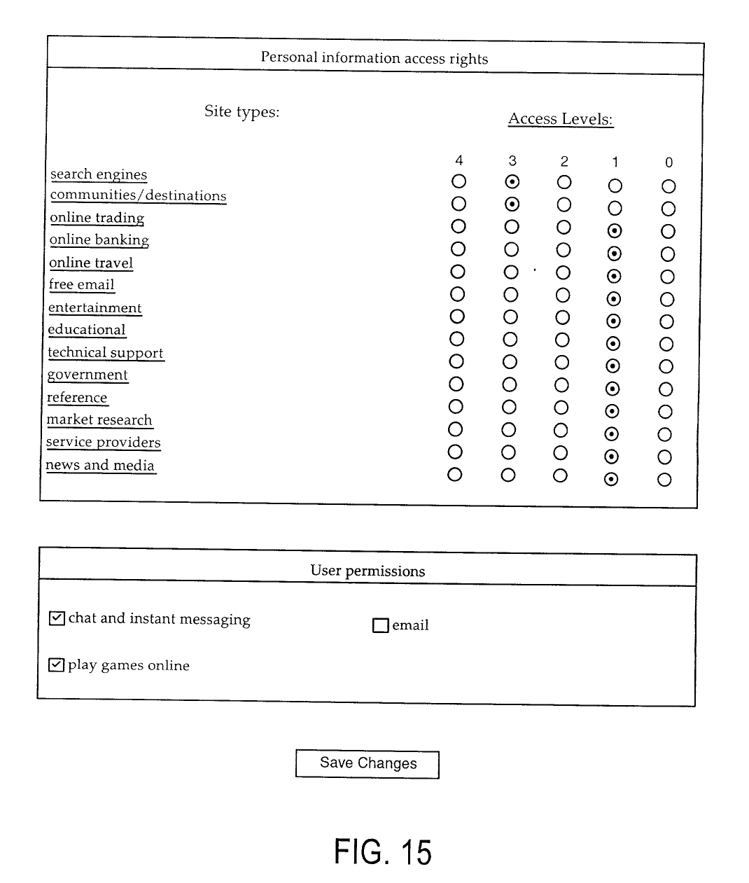

If the adult's identifying information validates, then the adult is presented with options for configuring the permissions granted to web site operators and online services regarding collection of personal information from the minor. For example, browser pages, such as depicted by FIGS. 14 and 15, are transmitted from the verification server 125 to the computer 200. The adult enters personal data about the minor as well as chooses the permission parameter associated with each type of web site, and clicks on the “Save Changes” button. The personal data and the permission parameters are then transmitted back to the verification server 125 where the minor's permission parameter set is stored in tables 500 and 540 (FIG. 5). The previous is exemplary only as an adult may supply personal information about the minor that is stored in table 500 in various other manners. When the permission parameter set is stored, for example, a username created by the adult and/or minor is stored in field 502, and each permission parameter selected by the adult is stored in a field 522. A verification user identifier is stored in field 504, and etc.

An exemplary permission parameter system involves three levels of permission to select from for a minor. These permission levels are level 2 which indicates that permission is granted to collect personal information from the minor; level 3 which indicates that permission is denied regarding collection of personal information from the minor; and level 4 which indicates that not only is permission denied regarding collection of personal information from the minor, but any information previously collected from the minor must be erased. Level 1 in such a system indicates that the Internet user is an adult. As recognized by one of ordinary skill in the art, other systems for defining permissions can be utilized with the present invention.

Table 540 stores the permissions granted regarding collection of personal information from the minor over the Internet as a permission parameter set. Specifically, fields 550 are utilized to store the type of web site or online service that the adult will allow operators of to collect personal information from the minor. Likewise, fields 554 are utilized to store the type of data that adults will allow operators of web sites and online services to collect from the minor. Either or both fields are utilized in various embodiments of the present invention, as well as other criteria for defining web sites, online services, and the type of data that they collect.

After a minor's permission parameter set has been established, the verification server 125 creates a cookie containing information regarding the permission levels granted by the parent regarding collection of personal information from the child. The verification server 125 then transmits the cookie to the computer 200 and copies the cookie onto the hard drive of computer 200 so that the cookie is associated with the minor's account on computer 200. Alternatively, if computer 100, which does not provide accounts for multiple users, is utilized by the minor, then the cookie stored on the computer 100 indicates that the computer is configured for manual login to the verification server 125, and the permission parameter set is utilized to assess COPPA verification whenever the minor accesses a web site or online service that must comply with COPPA.

Overview of Embodiments Utilizing a Session Variable

Other embodiments of the present invention employ a session variable associated with a user's Internet session. For example, a session variable is created by a logon server when a web server redirects an Internet user's Internet session to the logon server. The logon server utilizes Internet session information contained in the Internet user's URL request that was transmitted to the web server and subsequently transmitted from the web server to the logon server. Exemplary data to associate the session variable with is the temporary internet protocol (IP) address assigned to the Internet user's computer that is passed in URL requests transmitted by the Internet user's computer. For example, a session variable is set to an Internet user's temporary IP address.

After being created, the logon server stores the session variable on the logon server and/or an information server, e.g., by transmitting the session variable to the information server; and is utilized to identify the Internet user for web sites and online services during the Internet user's Internet session. When an Internet user accesses a web site, the server hosting the web site checks to determine whether a user identifier was passed from the Internet user's computer to the web server. If a user identifier was not passed, then the web server redirects the user's Internet session, as described supra, to a logon server. At the logon server, the Internet user enters her logon information, for example via a browser page transmitted from the logon server to the Internet user's computer, and once the logon is complete, i.e., the logon data is transmitted to the logon server, the logon server stores a session variable, as described above, that also contains the user's identifier. The logon server then redirects the user's Internet session back to the original web server, and passes the user's identifier to the web server.

When the Internet user accesses another web site, the new server hosting the web site redirects the user's Internet session to the logon server. Because the Internet user is already logged onto the logon server, and is utilizing the same Internet session, the logon server simply matches the user's Internet server with the session variable stored on the logon server, and returns the user's identifier to the new web server.

Once the web server hosting the accessed web site or online service has determined that a user identifier is associated with the user, the web server utilizes a conduit object, i.e., a program designed to communicate, for example, with an information server. Alternatively, the conduit object may communicate with the logon server or other computer used to store personal information and permission parameter sets for each Internet user, either collectively or independently. The conduit object passes a site identifier and a user's identifier to the information server, which in turn determines what personal information fields the web site associated with the site identifier is allowed to collect from the user. Access between the web server and the information server is conducted over an encrypted, secure connection. Additionally, in certain embodiments, only internet protocol addresses of web sites known by the information server are allowed to connect to the information server.

The information server, or other computer storing users' personal information and permission parameter sets, utilizes the site identifier in conjunction with the user's identifier to determine whether the web site or online service accessed by the Internet user is permitted to receive personal information about the Internet user. Based upon the result of determining whether the web site or online service is permitted to receive personal information about the Internet user, the information server, or other computer storing users' personal information and permission parameter sets, transmits personal information about the Internet user to the server hosting the web site or online service. The personal information transmitted ranges from no personal information transmitted to all of the Internet user's personal information transmitted, depending upon what the Internet user's permission parameter set dictates may be transmitted.

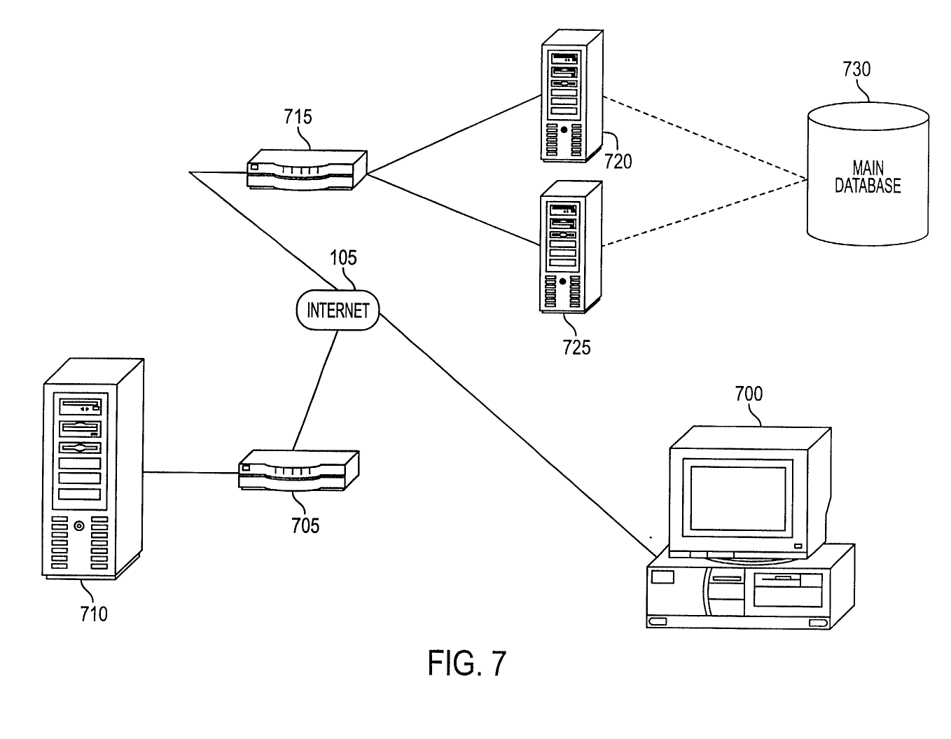

Adverting to FIG. 7, an arrangement of computers for carrying out certain embodiments of the present invention utilizing a session variable is described. An Internet user connects to the Internet 105 to, for example, an Internet server 710, by transmitting a URL request from computer system 700. The Internet server 710 hosting the requested URL receives the transmission from computer system 700 and searches for a user identifier contained in the URL request.

If Internet server 710 recognizes a user identifier in the transmission from computer system 700, the Internet server 710 queries information server 725 and passes the user identifier, as well as a site identifier associated with the requested URL, to an information server 725. The information server 725 verifies that the site identifier is valid, then retrieves permissions that the Internet user, or Internet user's guardian, at computer system 700 has granted for release of personal information. Retrieval of permissions is performed, for example, by a database query on database 730. The information server 725 then passes what values, i.e., name, address, age, etc., of personal information the operator of the requested URL may receive from the Internet user at computer system 700. In certain embodiments, the personal information passed to the operator of the requested URL is in a read only format.

If there is not a user identifier in the URL request from computer system 700 to Internet server 710, the Internet server 710 redirects the Internet user's Internet session, for example, to a logon server 720, before granting access to the requested URL. The Internet user at computer system 700 logs onto logon server 720. The logon process is the same, or similar, to logon processes described supra. The logon server 720 verifies that the Internet user has a permission parameter set stored in the database 730, and stores a session variable, as described above, that is associated with the user's identifier, and transmits the user's identifier to the Internet server 710. The Internet server 710 stores the user's identifier, then queries the information server 725 utilizing a conduit object in order to receive any personal information that the Internet user has granted permission to be released to the web site or online service. Querying the information server 725 may occur while the Internet user is accessing the web site or online service, or at any time thereafter.

Specific Embodiment Utilizing a Session Variable

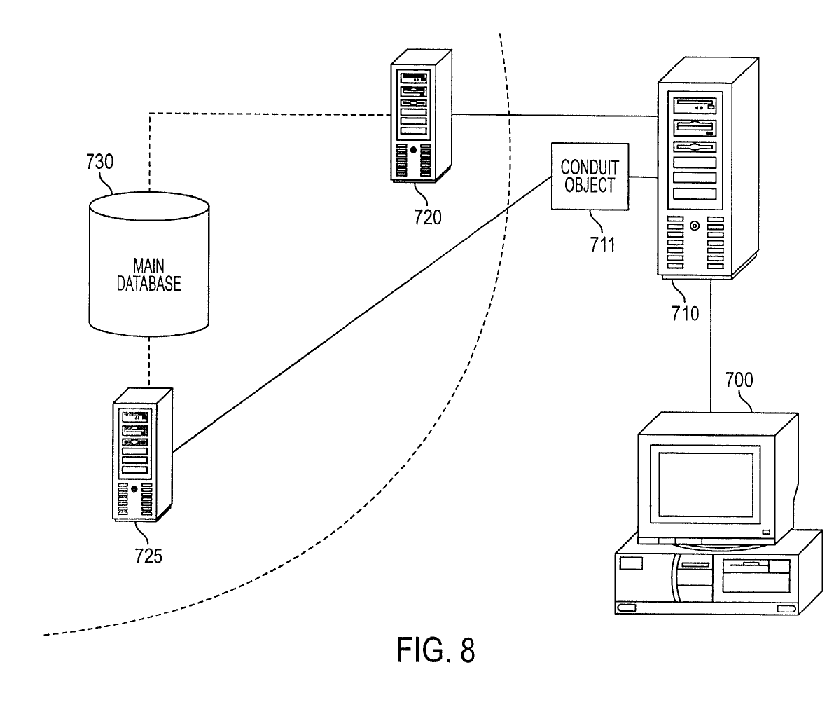

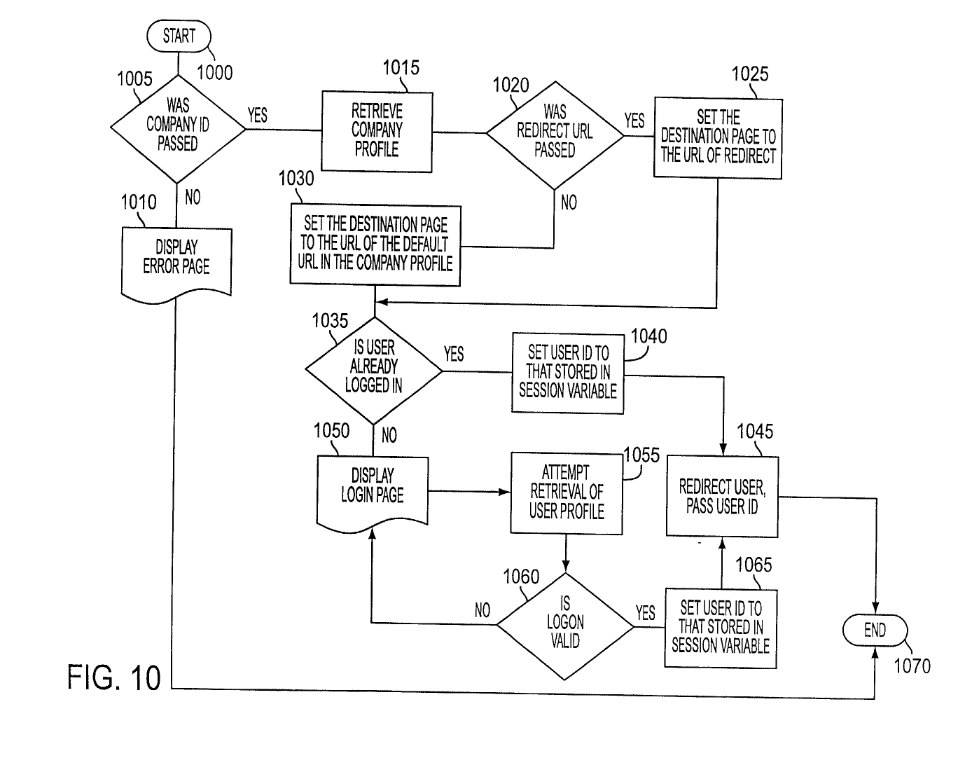

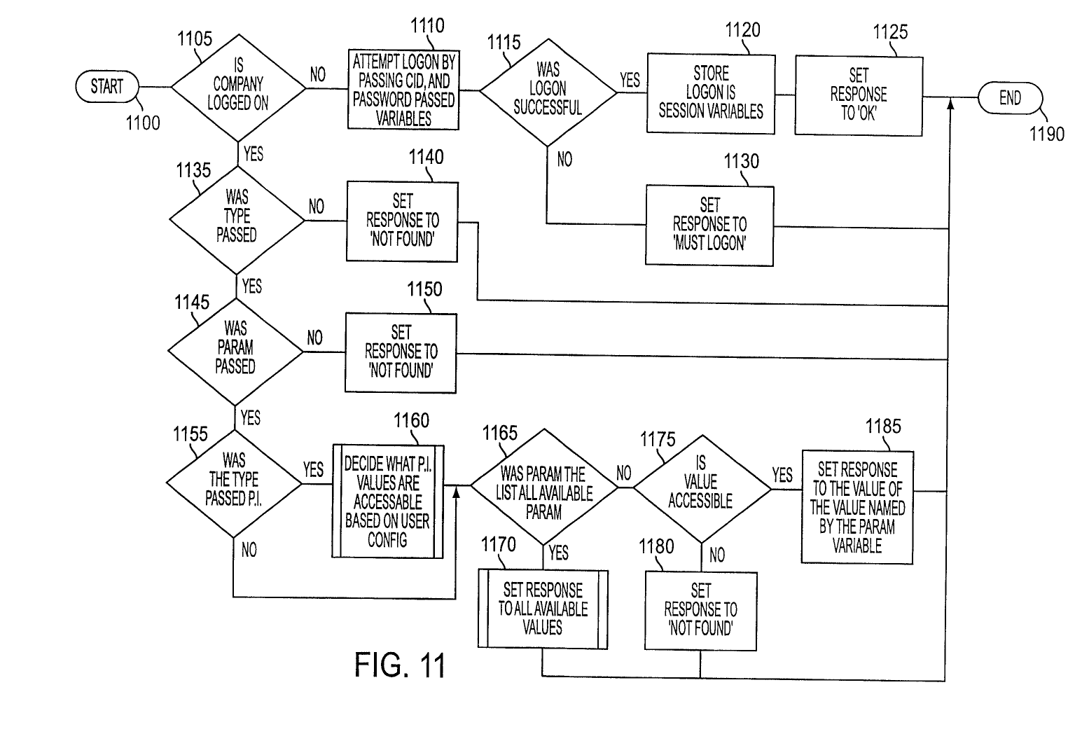

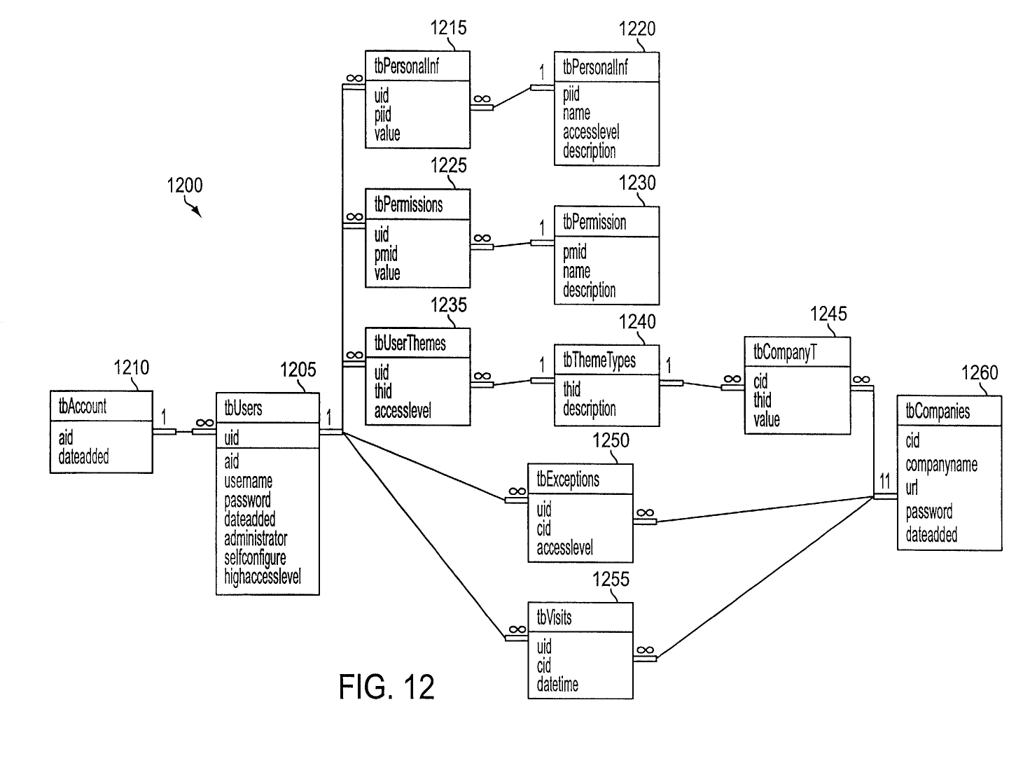

Adverting to FIGS. 8-12, an embodiment of the present invention utilizing a session variable stored on computer system 700 is described. A session variable is a value, for example a unique identifier, such as a copy of the temporary IP address that is assigned to computer system 700 when the Internet user accesses the Internet. The session variable is stored on logon server 720. The session variable for an Internet user is established for purposes of associating a permission parameter set that governs granting and/or denying release of personal information about the Internet user.

Each Internet user's Internet session has unique qualities, e.g., a unique IP address, that allow an Internet server to distinguish between multiple Internet users based upon each Internet user's corresponding Internet session. Even when the same computer 700 is utilized by different Internet users, each new Internet session is distinguishable from the previous one. Therefore, requiring an Internet user to logon to a specified Internet server results in associating the Internet user's unique Internet session with the Internet user's unique identifier established for personal information permission purposes. When an Internet user disconnects from the Internet, that Internet user's unique session information is terminated and that Internet user's unique identifier is no longer accessible. The session variable will, for example, time out and be erased from the logon server 720 after a certain period of inactivity, for example fifteen minutes.

A typical transaction begins with an Internet user connecting to the Internet and transmitting a URL request from computer system 700. Although displayed as a desk-top computer, computer system 700 may be any form of computer system, including a cellular telephone or other hand-held device with a web application protocol (WAP) browser or other web compatible software, a laptop computer, a computer networked to a local area network (LAN), etc.

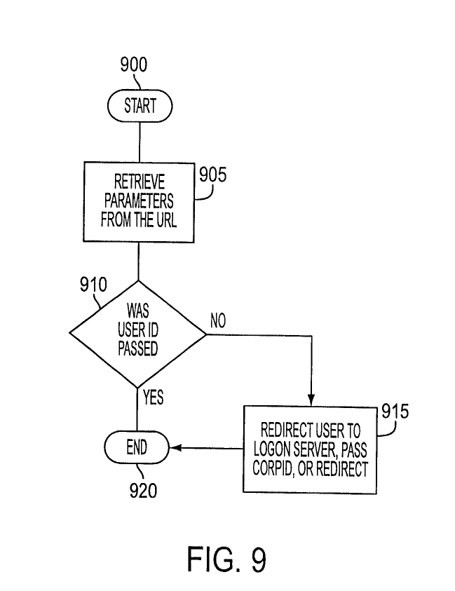

The URL request transmitted from computer system 700 is received at Internet server 710 which hosts the web page or online service requested by the Internet user at computer system 700. The Internet server 710 runs a parameter script, or other program, on the first, or default, page of the web site requested by the Internet user at computer system 700. Alternatively, the parameter script, or other program, may be implemented through a variety of Internet servers that share some form of common gateway and/or interface scripting. Data from the URL request transmitted from computer system 700 is passed to the parameter script, or other program, at step 905 (FIG. 9).

The parameter script, or other program, scans the data from the URL request to verify whether a user identifier was passed to the Internet server 710. If a user identifier was passed to the Internet server 710, processing continues at the information server 725 as described infra. However, if no user identifier was passed to the Internet server 710, the Internet server 710 redirects the Internet user's Internet session to a logon server 720 at step 915. When Internet server 710 redirects the Internet user's Internet session to the logon server 720, the Internet server 710 passes a site identifier associated with the operator of the requested URL, as well as a target URL that the logon server 720 directs the Internet user's Internet session to after the Internet user's logon is complete. If no target URL is passed from the Internet server 710 to the logon server 720, the logon server 720 redirects the Internet user's Internet session to a default URL residing in a profile associated with the site identifier.

When the Internet user of computer system 700 is redirected to the logon server 720, the logon server 720 verifies whether a site identifier was passed at step 1005. If a site identifier was not passed to the logon server 720, an error page is displayed at step 1010, via a browser page transmitted from the logon server to computer system 700 for example, and processing ends at step 1070. However, if a site identifier was passed, then the logon server retrieves a site profile at step 1015. For example, retrieval of a site profile is a query performed on a database 730. At step 1020, the logon server 720 verifies whether a target URL was passed. If a target URL was passed to the logon server 720, the logon server 720 sets the destination page to the target URL that was passed at step 1025. However, if a target URL was not passed to logon server 720, the destination page is set to the default URL from the site profile at step 1030.

At step 1035, the logon server 720 determines whether the Internet user at computer system 700 is already logged in. For example, determining if the Internet user at computer system 700 is already logged in to the logon server 720 is performed by checking for a session variable residing on logon server 720 that corresponds to the Internet user's Internet session. If the Internet user at computer system 700 is already logged in to the logon server 720, a user identifier associated with the session variable residing on logon server 720 is copied into the user identifier field in the URL request at step 1040. The logon server 720 then redirects the Internet user's Internet session to the destination page and passes the user identifier to the internet server 710 at step 1045. Utilizing a session variable associated with the Internet session of each Internet user who is logged on to logon server 720 is a fast, economical manner of giving web sites and online services access to Internet user's personal information, while allowing the Internet users themselves to control what personal information is released to particular web sites and online services.

If the Internet user is not already logged into the logon server 720, a logon page is displayed at step 1050. For example, a browser window containing fields for receiving logon information such as a username and password is transmitted from the logon server 720 to the computer system 200. The Internet user transmits logon information to the logon server 720 by, for example, clicking a button. At step 1055 the logon server attempts to retrieve the permission parameter set associated with the Internet user at computer system 700 from database 730. If the Internet user's name is not stored in the main database 730, the Internet user of computer system 700 is prompted to create a permission parameter set, as described supra in relation to FIGS. 14 and 15. At step 1060, the logon server 720 verifies that the logon for the Internet user at computer system 700 is valid. If the logon is not valid, logon server 720 proceeds back to step 1050 and displays a logon page. However, if the logon is valid, the logon server 720 stores a session variable and associates the user identifier to the session variable at step 1065. The logon server 720 then redirects the Internet user's Internet session to the destination page, and passes the user's identifier to the internet server 710 at step 1045.

After the Internet user's Internet session is redirected to the destination page, as defined at either step 1025 or step 1030, the Internet user at computer system 700 is granted access to the website or online service associated with the originally requested URL transmitted from computer system 700. At this point, or at a later point in time, the internet server 710 utilizes a conduit object, a program designed to communicate over a secure connection utilizing a secure protocol, for example hyper-text protocol secure (https), hosted on the internet server 710, to communicate with the information server 725 over a secured, encrypted connection. The internet server 710 passes several variables to the information server 725. For example, the internet server 710 passes a site identifier, a site password, the user's identifier, and the type of information for which permission is sought, i.e., the name of the value being retrieved such as first name, last name, address, gender, age, etc.

The information server 725 receives a query from internet server 710, and transmits a response to internet server 710 stating whether the website or online service that the Internet user at computer system 700 accessed may receive personal information about the Internet user. Initially, a personal information request is received at step 1100. At step 1105, the information server 725 verifies whether the operator of the website or online service is logged on. If the operator of the website or online service is not logged on, the information server 725 attempts an automatic logon using the passed site identifier and the passed site password at step 1110. At step 1115, the information server 725 verifies whether the logon was successful. If the logon was not successful, at step 1030 the information server sends a response, for example via electronic mail, or as a browser page, to internet server 710 that the operator of the website or online service must logon. If the logon was successful, the information server 725 stores the site logon in a session variable at step 1120. The information server 725 then sets a response to “OK” at step 1125 and transmits this response to the internet server 710. The internet server 710, which is now logged on to the information server 725, resubmits the personal information collection query to the information server 725.

After the information server 725 has determined that the operator of a website or online service is logged on at step 1105, the information server 720 verifies whether a variable representing the type of information requested was passed at step 1035. If no type variable was passed, the information server 720 sets the response to “not found” and transmits this response to the internet server 710. However, if a type variable was passed, the information server 720 determines whether a parameter value was passed at step 1145. If a parameter value was not passed, the information server 725 sets the response to “not found” at step 1150 and transmits this response to the internet server 710.

If a parameter value was passed, the information server 725 verifies whether the type of information sought to be collected is personal information at step 1155. If personal information is not sought, the information server 725 continues processing at step 1165, by determining whether the parameter value represents a list of all available parameters for the user of computer system 700. However, if personal information is sought, at step 1160 information server 725 decides what personal information values are accessible to the operator of the website or online service based upon the permission parameter set established by the Internet user, or by the Internet user's guardian.

If a determination is made that the passed parameter represents all of the available values for the Internet user at computer system 700 at step 1165, a response indicating all available values is set at step 1170, and this response, along with the data representing all available values, is transmitted to the Internet server 710. However, if the passed parameter does not indicate all available values for the Internet user at computer system 700, the information server 725 determines whether the requested value is accessible to the operator of the website or online service at step 1175. If the value is not accessible to the operator of the website or the online service, information server 725 sets a response to “not found” at step 1180 and transmits this response to internet server 710. However, if the requested value is accessible to the operator of the website or online service, the information server 725 sets the response to the personal information request equal to the value named by the parameter variable at step 1185, and transmits this response, i.e., the actual value requested, to the internet server 710.

Hardware Overview for Internet Servers

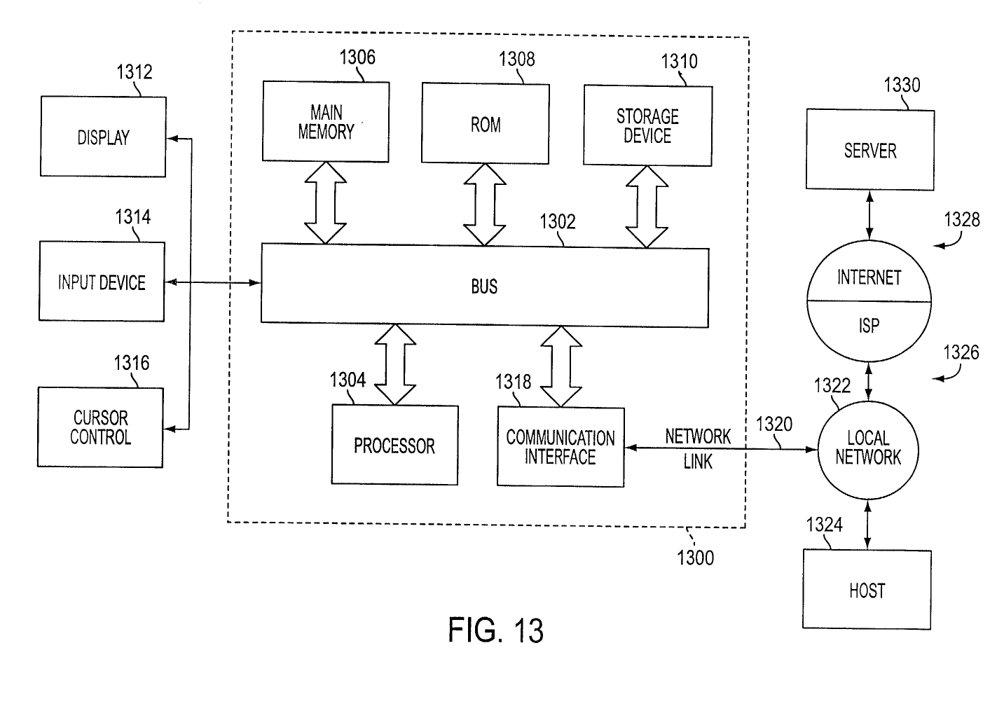

FIG. 13 is a block diagram that illustrates a computer system 1300, such as web server 115/lnternet server 710, verification server 125, logon server 720 and/or information server 725, upon which an embodiment of the invention, as previously described, may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables, for example, session variables, or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

The invention is related to the use of computer system 1300 for automatically determining whether a web site operator or online service may collect personal information from a person accessing a web site. According to certain embodiments of the invention, automatic determination of whether a web site operator or online service may collect personal information from a person accessing a web site is provided by computer system 1300 in response to processor 1304 executing one or more sequences of one or more instructions contained in main memory 1306. Such instructions, for example instructions that perform a process as depicted in any of FIGS. 3, 4, or 9-11, may be read into main memory 1306 from another computer-readable medium, such as storage device 1310. Execution of the sequences of instructions contained in main memory 1306 causes processor 1304 to perform the process steps described above. One or more processors in a multi-processing arrangement may also be employed to execute the sequences of instructions contained in main memory 1306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1304 for execution. Such a medium may take many forms, including but not limited to, non-volatile media, volatile media, and transmission media. Non-volatile media include, for example, optical or magnetic disks, such as storage device 1310. Volatile media include dynamic memory, such as main memory 1306. Transmission media include coaxial cables, copper wire and fiber optics, including the wires that comprise bus 1302, or the signals carried thereby. Transmission media can also take the form of electromagnetic, acoustic, or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Various forms of computer readable media may be involved in carrying one or more sequences of one or more instructions to processor 1304 for execution. For example, the instructions may initially be borne on a magnetic disk of a remote computer. The remote computer can load the instructions into its dynamic memory and send the instructions over a telephone line using a modem. A modem local to computer system 1300 can receive the data on the telephone line and use an infrared transmitter to convert the data to an infrared signal. An infrared detector coupled to bus 1302 can receive the data carried in the infrared signal and place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 1318 sends and receives electrical, electromagnetic or optical waves or signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the worldwide packet data communication network, now commonly referred to as the “Internet” 1328. Local network 1322 and Internet 1328 both use electrical, electromagnetic or optical waves or signals that carry digital data streams. The waves or signals through the various networks and the signals on network link 1320 and through communication interface 1318, which carry the digital data to and from computer system 1300, are exemplary forms of carrier waves transporting the information.

Computer system 1300 can send messages and receive data, including program code, through the network(s), network link 1320, and communication interface 1318. In the Internet example, a Internet server 710 (not shown) might transmit a requested for personal information about an Internet user through Internet 1328, ISP 1326, local network 1322 and communication interface 1318. In accordance with the invention, one such request for personal information is automatically answered by an information server 725 (not shown) based upon a session variable and a permission parameter set associated with a particular Internet user. Both the Internet server 710 and the information server 725 could have a hardware arrangement as depicted in FIG. 13.

The present invention, including scripts running on web servers and the programming necessary to make the verification server 125, logon server 720, and information server 725 operate in accord with the inventive method, may be embodied in a computer system as described above, or it may be a program designed to operate on any configuration for a computer system.

By allowing web sites and online services to collect users' identifiers, embodiments of the present invention enable a system where each user's personal information is stored in a centralized location, is accessible to web site operators and online services, but is not under the control of web site operators or online services. When a web site or online service queries the centralized location with a request for personal information associated with Internet user's identifiers, the centralized location transmits personal information in a read-only form, thus preventing copying, selling and other misuses of personal information.

The present invention also allows each user, or each user's guardian, to determine what personal information, if any, is released, and to what type of web sites or online services. Each user, or each user's guardian, makes such a determination by defining a permission parameter set that is used to determine whether a particular web site or online service may receive personal information about a particular Internet user, and if so what personal information will be released.

Other embodiments of the present invention permit verification of permission to collect personal information from minors accessing web sites or Internet services without requiring guardians to grant permission each time a minor accesses a new web site or Internet service. Guardians are able to configure the level of permission regarding personal information that can be collected from minors via the Internet. The configuration, i.e., permission parameter set, is stored electronically in a central location and is utilized to assess whether a web site or Internet service accessed by a minor may collect personal information from that minor, i.e., a person less than 13 years old.

Those skilled in the art will recognize, or be able to ascertain using no more than routine experimentation, many equivalents to the specific embodiments of the invention specifically described herein. Such equivalents are intended to be encompassed in the scope of the following claims.

What is claimed is:

1. A method for determining whether personal information may be collected from a computer user accessing an Internet site, comprising the steps of:
storing at a centralized location for each user a permission parameter set that governs collection of personal information regarding the user associated with each permission parameter set;
retrieving a permission parameter associated with the user when the user accesses the Internet site; and
determining whether the Internet site is able to obtain personal information about the user based upon the stored permission parameter set regarding the user; and
obtaining personal information about the user at the Internet site based upon the determination whether the Internet site is able to obtain personal information about the user.

2. The method of claim 1, further comprising the step of:
determining what personal information the Internet site is able to collect from the user based upon the user's permission parameters; and wherein
each permission parameter set is defined by a person having authority to define a permission parameter set for the user

3. A method for determining whether personal information may be collected from a computer user accessing an Internet site comprising the steps of:
transmitting an Internet site request from the user's computer to a first Internet server that functions as the Internet site;
redirecting the Internet site request to a second Internet server;
retrieving data from the user's computer by the second Internet server in response to the redirected Internet site request;
determining whether the computer user is older than a predetermined age at the second Internet server based at least in part upon the retrieved data from the user's computer; and
transmitting a permission parameter that indicates what personal information may be collected from the computer user, based upon determining whether the computer user is older than a predetermined age, from the second Internet server to the first Internet server.

4. The method of claim 3, wherein:
the data retrieved from the user's computer is stored in a cookie on the user's computer accessible by the second Internet server.

5. A method for determining whether personal information may be collected from a computer user accessing an Internet site comprising the steps of:
transmitting an Internet site request from the user's computer to a first Internet server that functions as the Internet site;
redirecting the Internet site request to a second Internet server;
retrieving data from the user's computer by the second Internet server in response to the redirected Internet site request;
retrieving a permission parameter set that governs collection of personal information from the user utilizing the data retrieved from the user's computer;
determining at the second Internet server whether the computer user has personal information authorized for collection based at least in part upon the retrieved permission parameter set; and
transmitting a permission parameter that governs what personal information may be collected from the computer user, based at least in part upon the permission parameter set, from the second Internet server to the first Internet server.

6. The method of claim 5, wherein the step of retrieving data from the user's computer further comprises the steps of:
prompting the user to enter identifying information; and
receiving identifying information from the user wherein the step of retrieving a permission parameter set further comprises the steps of:
determining whether a pre-existing permission parameter set is associated with the user based upon the identifying information;
retrieving the permission parameter set associated with the user if a pre-existing permission parameter set exists; and
creating a permission parameter set associated with the user if a pre-existing permission parameter set does not exist by receiving permission parameter data from the user.

7. The method of claim 6, wherein creating a permission parameter set associated with the user further comprises the steps of:
prompting the user to provide age verifying information;
receiving age verifying information from the user;
validating the age of the user based upon the age verifying information;
if the age of the user validates as over a predetermined age, then:
storing the user's identifying information in association with the user's age;
and if the age of the user does not validate as over a pre-determined age, then:
prompting the user for age verifying information from an adult;
receiving age verifying information from an adult;
validating the adult's age verifying information;
prompting the adult to create a permission parameter set for the user;
receiving the permission parameter set data for the user; and
storing the user's permission parameter set.

8. A method for determining whether personal information may be collected from a computer user accessing an Internet site comprising the steps of:
receiving a redirected Internet site request at a verification computer;
retrieving data from the user's computer by the verification computer;
determining whether the computer user is older than a predetermined age based upon the data retrieved from the user's computer;
retrieving a permission parameter set from storage in association with the verification server that governs what personal information is collectible from the user; and
transmitting to an Internet site identified in the Internet site request a permission parameter based upon the permission parameter set that governs what personal information about the user may be collected.

9. The method of claim 8, wherein:
the data retrieved from the user's computer is stored in a cookie accessible by the verification computer.

10. The method of claim 8, further comprising the steps of:
prompting the user to enter identifying information;
receiving the user's identifying information; and
determining whether a pre-existing permission parameter set is associated with the user utilizing the identifying information.

11. The method of claim 10, when a pre-existing permission parameter set associated with the user does not exist, further comprising the steps of:
prompting the user to provide age verifying information;
receiving the user's age verifying information;
validating the age of the user based upon the age verifying information;
if the age of the user validates as over a pre-determined age, then:
storing the user's identifying information in association with the user's age as the permission parameter set; and
if the age of the user does not validate as over a pre-determined age, then:
prompting the user for age verifying information from an adult;
receiving the adult's age verifying information;
validating the adult's age verifying information;
prompting the adult to create a permission parameter set for the user; and
storing the user's permission parameter set.

12. A method for determining whether personal information may be collected from a computer user accessing an Internet site comprising the steps of:
transmitting an Internet site request containing at least a computer identifier from a user's computer to a first Internet server;
redirecting the Internet site request to a second Internet server;
determining a personal identifier associated with the user at the second Internet server utilizing the computer identifier;
transmitting the personal identifier associated with the user to the first Internet server;
storing the personal identifier associated with the user on the first Internet server;
transmitting a site identifier associated with the requested Internet site, and transmitting the user's personal identifier to a third Internet server;
retrieving a permission parameter set associated with the user utilizing the user's personal identifier, at the third Internet server;
determining whether the requested Internet site is authorized to receive personal information about the user based upon the permission parameter set established for the user and based upon the site identifier; and
transmitting personal information about the user to the first Internet server, based upon the permission parameter set and the site identifier.

13. The method of claim 12, wherein determining a personal identifier associated with the user at the second Internet server utilizing the computer identifier, comprises the steps of:
determining whether a session variable stored on the second Internet server is associated with the computer identifier; and
setting a user identifier value from the session variable associated with the computer identifier as the computer user's personal identifier if there is a session variable associated with the computer identifier stored on the second Internet server.

14. The method of claim 12, where determining a personal identifier associated with the user at the second Internet server utilizing the computer identifier, comprises the steps of:
determining whether a session variable stored on the second Internet server is associated with the computer identifier;
if there is not a session variable associated with the computer identifier stored on the second Internet server:
prompting the user to log on to the second Internet server;
receiving the user's log on data;
retrieving the personal identifier associated with the user utilizing the user's log on data;
storing on the second Internet server the personal identifier associated with the user in a session variable associated with the computer identifier; and
setting the personal identifier associated with the user in the session variable associated with the computer identifier as the computer user's personal identifier to be transmitted to the first Internet server.

15. A method for determining whether personal information may be collected from a computer user accessing an Internet site comprising the steps of:
receiving a redirected Internet site request containing at least a computer identifier at an Internet server;
determining a personal identifier associated with the user at the Internet server utilizing the computer identifier;
transmitting the personal identifier associated with the user to the Internet site requested by the user;
receiving a site identifier associated with the Internet site requested by the user and the personal identifier associated with the user;
determining whether the requested Internet site is authorized to receive personal information about the user, and determining what personal information the Internet site is authorized to receive, based upon a permission parameter set established for the user; and
transmitting personal information about the user to the first Internet server, based upon the permission parameter set

16. A computer-readable medium bearing instructions for determining whether personal information can be collected from a computer user, said instructions, when executed, are arranged to cause a computer system to perform the steps of:
receiving a redirected Internet site request containing at least a computer identifier at an Internet server;
determining a personal identifier associated with the user at the Internet server utilizing the computer identifier;
transmitting the personal identifier associated with the user to the Internet site requested by the user;
receiving a site identifier associated with the Internet site requested by the user and the personal identifier associated with the user;
determining whether the requested Internet site is authorized to receive personal information about the user, and determining what personal information the Internet site is authorized to receive, based upon a permission parameter set established for the user; and
transmitting personal information about the user to the first Internet server, based upon the permission parameter set.

17. A computer-readable medium bearing instructions for determining whether personal information can be collected from a computer user, said instructions, when executed, are arranged to cause a computer system to perform the steps of:
storing at a centralized location permission parameters defined by a person having authority to establish a permission parameter set for the user that govern collection of personal information regarding the user;
retrieving permission parameters associated with a user when the user accesses an Internet site;
determining whether the Internet site is able to obtain personal information from the user based upon the user's permission parameters; and
obtaining personal information about the user at the Internet site based upon the determination whether the Internet site is able to obtain personal information about the user.

18. A computer-readable medium bearing instructions for determining whether personal information can be collected from a computer user, said instructions, when executed, are arranged to cause a computer system to perform the steps of:
receiving a redirected Internet site request at a verification computer;
retrieving data from the user's computer by the verification computer;
determining whether the computer user is older than a predetermined age based upon the data retrieved from the user's computer;
retrieving a permission parameter set that governs what personal information is collectible from the user; and
transmitting to an Internet site identified in the Internet site request a permission parameter based upon the permission parameter set that governs what personal information about the user may be collected.

19. A method for determining whether personal information may be collected from a computer user accessing an Internet site comprising the steps of:
receiving a uniform resource locator (URL) request from a computer user at an Internet server;
redirecting the computer user to a second Internet server to effectively request permission to collect personal information from the computer user;
receiving at least a permission parameter that indicates what personal information may be collected from the computer user; and
collecting personal information from the computer user indicated as collectible by the at least a permission parameter.

20. A method for determining whether personal information may be collected from a computer user accessing an Internet site comprising the steps of:
receiving a uniform resource locator (URL) request containing a computer identifier from a computer user at an Internet server;
establishing a communication connection with a second Internet server;
passing the computer identifier to the second Internet server over the communication connection;
passing a site identifier associated with the URL to the second Internet server over the communication connection;
requesting permission to receive personal information about the computer user from the second Internet server; and
receiving personal information from the second Internet server about the computer user indicated as releasable by a permission parameter set established for the computer user.

21. A computer-readable medium bearing instructions for determining whether personal information can be collected from a computer user, said instructions, when executed, are arranged to cause a computer system to perform the steps of:
receiving a uniform resource locator (URL) request containing a computer identifier from a computer user at an Internet server;
establishing a communication connection with a second Internet server;
passing the computer identifier to the second Internet server over the communication connection;
passing a site identifier associated with the URL to the second Internet server over the communication connection;
requesting permission to receive personal information about the computer user from the second Internet server; and
receiving personal information from the second Internet server about the computer user indicated as releasable by a permission parameter set established for the computer user.

22. A computer-readable medium bearing instructions for determining whether personal information can be collected from a computer user, said instructions, when executed, are arranged to cause a computer system hosting a web site to perform the steps of:
receiving parameters from a uniform resource locator (URL) request transmitted by a computer user;
determining whether a permission parameter is contained in the URL request;
redirecting the computer user's URL request to another computer system and passing an identifier associated with the URL to the other computer system, if there was no permission parameter contained in the URL request;
determining whether an identifier associated with the computer user is contained in the URL request;
redirecting the computer user to another computer system and passing an identifier associated with the URL to the other computer system, if there was no identifier associated with the computer user contained in the URL request;
determining whether the permission parameter requires deletion of stored personal information related to the computer user;
deleting stored personal information related to the computer user if the permission parameter requires deletion of stored personal information related to the computer user;
changing the permission parameter to indicate that no personal information may be collected from the computer user if the permission parameter requires deletion of stored personal information related to the computer user;
storing the permission parameter and the identifier associated with the computer user in a cookie placed on the user's computer; and
opening the requested URL while adhering to the permission granted by the permission parameter for collecting personal information from the computer user.

23. A computer-readable medium bearing instructions for determining whether personal information can be collected from a computer user, said instructions, when executed, are arranged to cause a computer system hosting a web site to perform the steps of:
receiving parameters from a uniform resource locator (URL) request sent by a computer user;
determining whether a personal identifier associated with the computer user is contained in the URL request; and
redirecting the computer user's URL request to another computer system and passing a site identifier associated with the requested URL to the other computer system, if there was no personal identifier associated with the computer user contained in the URL request.

24. A method for determining whether personal information may be collected from a computer user accessing an Internet site comprising the steps of:
transmitting a uniform resource locator (URL) request;
logging on to an Internet server that contains a permission parameter set that governs collection of personal information from the computer user; and
accessing the requested URL wherein personal information gathered resulting from the computer user's access to the requested URL is controlled by the permission parameter set.

25. A method for determining whether personal information may be collected from a computer user accessing an Internet site comprising the steps of:
transmitting a uniform resource locator (URL) request to an Internet server;
transmitting information related to age validation to a second Internet server;
transmitting information used to establish a permission parameter set for governing collection of personal information from the computer user to the second Internet server; and
accessing the requested URL on the first Internet server wherein personal information gathered resulting from the computer user's access to the requested URL is controlled by the permission parameter set.

26. An apparatus for implementing a method for determining whether personal information may be collected from a computer user accessing an Internet site, the method comprising the steps of:
storing at a centralized location for each user a permission parameter set that governs collection of personal information regarding the user associated with each permission parameter set;
retrieving a permission parameter associated with the user when the user accesses the Internet site; and
determining whether the Internet site is able to obtain personal information about the user based upon the stored permission parameter set regarding the user; and
obtaining personal information about the user at the Internet site based upon the determination whether the Internet site is able to obtain personal information about the user.
